(19) United States
(12) Patent Application Publication
(10) Pub. No.: US 2023/0356407 A1
(43) Pub. Date: Nov. 9, 2023

(54) A CONTROLLER FOR A PAINT ROBOT

(71) Applicant: ABB Schweiz AG, Baden (CH)

(72) Inventors: Andreas Skaar, Bryne (NO); Stian Nese, Bryne (NO); Cato Andre Jensen, Stavanger (NO); Morten Mossige, Nærbø (NO)

(21) Appl. No.: 18/044,809

(22) PCT Filed: Sep. 17, 2020
(86) PCT No.: PCT/EP2020/076002

§ 371 Date: Mar. 10, 2023

(51) Int. Cl. B05B 12/12; G05B 19/4155; B05B 13/04; B25J 13/08; B25J 9/00; B25J 11/00

(52) U.S. Cl. CPC B25J 11/0075; B05B 12/126; B05B 13/0431; B05B 13/0452; B25J 9/0093; B25J 13/088; G05B 19/4155; G05B 2219/40269; G05B 2219/45065

(57) ABSTRACT

A robot controller is adapted to execute a program an indication of a setpoint speed of a robot arm, an indication of a contemporaneous setpoint fluid flow per unit time of a spray gun supported by the robot arm, and an indication of a contemporaneous further setpoint quantity of the spray gun. The robot controller is configured to obtain an estimate of actual speed of the robot arm; determine whether the estimate deviates from the setpoint speed; and, in case of a deviation, adjust the setpoint fluid flow per unit time in accordance with a first compensation function. In an embodiment, the robot controller is further configured to concurrently adjust, in case of a deviation, the further setpoint quantity in accordance with a second compensation function, which is different from the first compensation function.

### TECHNICAL FIELD

The present disclosure relates to the field of robotic control and in particular to a robot controller for a robot manipulator operating a spray gun.

### BACKGROUND

With the long-standing use of paint robots, the problem of controlling a robot-operated spray gun has been approached in a multitude of ways.

US3525382 discloses a system which is controlled in an open-loop fashion by a program that specifies both a tool velocity and a flow of an application material from the tool.

EP0145991 discloses a robot-carried spraying device, which is associated with measuring devices for determining a translation speed of the spraying device and flow control devices controlling the fluid flow as a function of the translation speed. This aims to achieve delivery of a constant amount of fluid per unit length of the workpiece.

US5373221 discloses a system which simulates a robot’s execution of a programmed trajectory. The simulation takes into account a predefined corner rounding distance and similar parameters that may cause the actual trajectory to deviate from the programmed one. The simulated speed, rather than the speed according to the programmed trajectory, may be used to control the rate of a sealant flow from a sealant dispenser carried by the robot.

In US5292066, a command signal, which controls the flow of sealant from a sealing gun unit, is determined based on a commanded moving speed, at which the sealing gun is moved. A pre-taught program defines, directly or indirectly, the commanded moving speed, from which the flow of sealant is computed dynamically in the aim of a constant amount of sealant per unit length.

US4922852 discloses a robot having a controller programmed to guide a nozzle over the surface of a workpiece to dispense a bead of fluid thereon. The operation is guided on the basis of variables including a setpoint representing a desired total volume of fluid which is to be applied to a single workpiece. It is furthermore disclosed that the amount of fluid dispensed per unit distance may be controlled, namely, in view of a toolspeed signal emanating from the robot controller that represents the nozzle speed relative to the workpiece.

An important class of industrial paint robot controllers are programmed in terms of a setpoint spray gun speed and a setpoint fluid flow per unit time. This is because spray guns, unlike simple dispensers, are additionally configurable with respect to a number of further setpoint quantities, which may include settings related to atomization, electrostatic charging and various air flows per unit time that may be adjusted to modify the shape of the spray plume for a given nozzle and paint type. Simulation software for predicting the paint thickness that will result from a given combination of setpoint speed, fluid flow, air flow etc. exists but is perceived as relatively inaccurate by some actors, who tend to run preliminary paint tests to verify the thickness before initiating commercial operation.

A problem underlying the present disclosure is the automatic control of paint robots that are programmed in terms of setpoint spray gun speed and setpoint fluid flow per unit time.

### SUMMARY

One objective is to make available a robot controller for executing a program with indications of setpoint speed of a robot arm and setpoint fluid flow per unit time of a spray gun supported by the robot arm. Another objective is to propose such a robot controller with an ability to adapt the execution of the program to fluctuations in the actual speed of the robot arm. A still further objective is to propose a method for controlling a robot arm and spray gun in accordance with a program that contains indications of setpoint speed of the robot arm and setpoint fluid flow per unit time of the spray gun.

These and other objectives are achieved by the invention defined in the appended independent claims. The dependent claims are related to embodiments of the invention.

A first aspect of the invention relates to a robot controller adapted to execute a program comprising an indication of a setpoint speed of a robot arm, an indication of a contemporaneous setpoint fluid flow per unit time of a spray gun supported by the robot arm, and an indication of a contemporaneous further setpoint quantity of the spray gun. The robot controller is configured to: obtain an estimate of actual speed of the robot arm; determine whether the estimate deviates from the setpoint speed; and, in case of a deviation, adjust the setpoint fluid flow per unit time in accordance with a first compensation function.

By controlling the spray gun on the basis of the adjusted setpoint fluid flow per unit time (e.g., a reduced flow if the actual speed of the robot arm is found to be lower than the setpoint speed) rather than the setpoint fluid flow per unit time, the invention helps maintain the end result of the painting close to the intent of the programmer, notably as regards the expected thickness of the sprayed fluid. Assuming that the actual speed is dropping from the setpoint speed during execution of the program, the invention may prevent the local formation of overly thick layers. In the special case of spray painting, excessive thickness may lead to flaking or premature aging of the coating layer. The invention may furthermore avoid wasteful use of spray fluid. This way, in applications where the spray fluid is distributed in prefilled per-batch cartridges, the filling level need not include a substantial margin to account for potential waste. In conditions where the actual speed exceeds the setpoint speed, finally, the invention ensures completeness and reliability of the coating at all points of the workpiece.

The invention also provides for stable and well-conditioned automatic control. More precisely, because the setpoint fluid flow is used (without adjustment) unless a deviation of the actual speed from the setpoint speed is determined, the constant availability of a speed estimate is not crucial for the execution of the control. Accordingly, the robot controller according to the invention may be said to adaptively alternate between open-loop control of the spray gun (when the estimate of actual speed does not deviate from the setpoint speed or the estimate is not available) and closed-loop control (when a deviation is determined). Besides, as mentioned above, the dependence of the thickness on speed and other factors may only be known locally around an operating point (e.g., as an elasticity), so that forward calculation of the setpoint speed from the thickness may be considerably more difficult than finding suitable incremental adjustments.

A used herein, an “indication” of a quantity in a program or script refers to a value which has been entered in explicit human- or machine-readable form by the operator or a programmer. While additional quantities can be implicit from a program - and may be derived therefrom on the basis of calculations and known relationships with quantities that are indicated in the program - the intended meaning of “indication” does not cover such implicit quantities.

Further, two setpoint quantities are “contemporaneous” in the sense of the claims if they are to be observed or executed by the robot controller in coinciding or overlapping periods of time. For example, if the program instructs the robot controller to move the robot arm at setpoint speed v* over a portion of the workpiece while causing the spray gun to apply dq*/dt units of fluid and dp*/dt units of air per unit time, then v*, dq*/dt and dp*/dt are contemporaneous setpoint quantities. A common way of programming a paint robot is to let the robot arm move over the workpiece at constant speed along a path such that the spray plume visits all points of each surface to be painted; therefore, the robot arm may typically be configured to have piecewise constant setpoint speed in respective periods of time.

A “compensation function” is an at least locally valid, theoretical or empirical relationship between actual robot arm speed v and at least one quantity x (e.g., fluid flow per unit time, air flow per unit time) that influences the thickness h of sprayed liquid. A compensation function may be an expression R in the form R(v,x) = h. A compensation function may be expressed as an implicit function x̃(v) such that R(v,x̃(v)) = R(v*,x*) when the speed v is in a neighborhood of the setpoint speed v*; the robot controller may feed the implicit function x̃(v) evaluated for the estimated actual speed v to the spray gun as an adjusted setpoint value of x when the speed has been determined to deviate. The expression R, implicit function x̃ etc. may be represented analytically, as empirically fitted curves, value tables, an artificial neural network trained on representative examples or any other suitable machine-readable form.

As used herein, the term “spray gun” covers all products known in the field as atomizer gun, atomizer bell, paint bell, rotary bell atomizer, bell applicator and spray applicator. A spray gun in this sense may be adapted to apply a fluid, such as paint. There also exist spray guns for applying free-flowing dry powders in a powder coating applications, wherein the powder acts as solvent-free paint and thus is equivalent to a spray fluid.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

In one embodiment, the robot controller is further configured to take compensatory measures relating to the further setpoint quantity (e.g., atomization, air flow per unit time, spray plume geometry, electrostatic charging) in case of a determined speed deviation. Indeed, the robot controller may be configured to adjust, concurrently with the adjustment of the setpoint fluid flow per unit time, the further setpoint quantity in accordance with a second compensation function, which is different from the first compensation function. Because the second compensation function is defined independently from the first compensation function - and usually is different from the first compensation function as it relates to a different quantity -this embodiment makes it possible to adjust, in the case of a speed deviation, each setpoint value in an appropriate way. This is in the interest of an attractive end result with a high degree of uniformity within a batch of workpieces and between different batches.

In a second aspect, the invention provides a method of controlling a robot arm and a spray gun supported by the robot arm. The method comprises: obtaining a program comprising an indication of a setpoint speed of the robot arm and an indication of a contemporaneous further setpoint fluid flow per unit time of the spray gun and an indication of a contemporaneous further setpoint quantity of the spray gun; obtaining an estimate of actual speed of the robot arm; determining whether the estimate deviates from the setpoint speed; and adjusting, in case of a deviation, the setpoint fluid flow per unit time in accordance with a first compensation function.

A further aspect of the invention relates to a computer program containing instructions for causing a computer, or the robot controller in particular, to carry out the above method. The computer program may be stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storages of magnetic, optical or solid-state type. Still within the scope of “data carrier”, such memories may be fixedly mounted or portable.

### BRIEF DESCRIPTION OF THE DRAWINGS

Aspects and embodiments are now described, by way of example, with reference to the accompanying drawings, on which:

FIG. 1 shows an industrial paint system comprising a robot arm equipped with a spray gun, a robot controller configured in accordance with an embodiment of the present invention, and a conveyor arrangement for bringing a workpiece into and out of the operating area of the robot arm;

FIG. 2 is a flowchart of a method according to an embodiment of the invention;

FIGS. 3 to 5 are plots of various compensation functions for use in embodiments of the invention; and

FIG. 6 shows an example architecture of cooperating control algorithms suitable for controlling a robot arm and connected spray gun.

### DETAILED DESCRIPTION

The aspects of the present disclosure will now be described more fully hereinafter with reference to the accompanying drawings, on which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

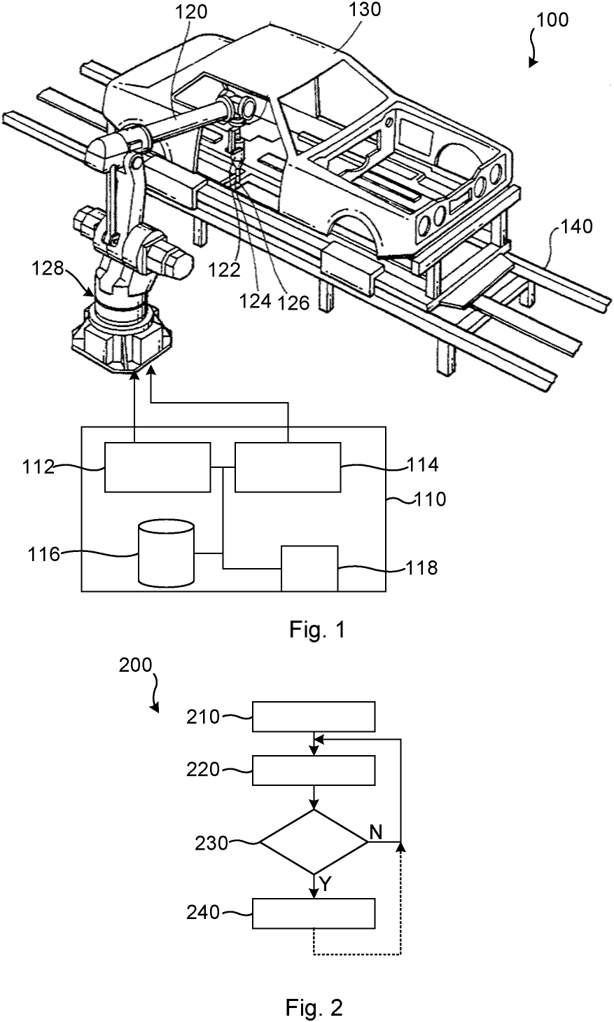

FIG. 1 shows an industrial paint system 100 generally comprising a robot arm 120, a robot controller 110 and a conveyor arrangement 140. The robot arm 120 comprises multiple segments joined by rotatable or linear joints, which extends from a base 128 and supports, at its outer end, a spray gun 122 adapted for spraying fluid through a spray nozzle 124 onto surfaces of a stationary or moving workpiece 130 on the conveyor arrangement 140. The robot arm 120 may comprise (not shown) supply lines for feeding spray fluid, air, gases etc. to the spray gun 122, return lines for collecting excess fluid etc., as well as an electric harness for supplying electric power and control signals. To allow the spray gun 122 to reach various surfaces of the workpiece 130 and cover these efficiently, the robot arm 120 is movable by translations and/or rotations, and the spray gun 122 itself may be rotatable with respect to the robot arm 120. The speed of the robot arm 120 during such movements may be measured or estimated with reference to a tool center point (TCP) 126. The setpoint speed may refer to the TCP 126 as well.

The lower part of FIG. 1 shows an example structure of the robot controller 110, which comprises a motion control system 112, a process control system 114, a memory 116 suitable for storing executable software, including various programs, such as spray programs with indications of the setpoint quantities, and a user interface 118 configured to display various aspects of a current condition of the paint system 100 and to accept commands input by an operator. The programs may be prepared using the user interface 118 or uploaded directly to the memory 116. The motion control system 112 is primarily in charge of feeding the robot arm 120 with motion control signals directed to actuators therein and monitoring the robot arm 120 through rotary position sensors, torque/strain/pressure sensors and the like. The process control system 114 is primarily responsible for controlling aspects of the spray gun 122, such as atomization, electrostatic charging, various air flows modifying the shape of the spray plume, cleaning and replacement of nozzles.

In some embodiments, the motion control system 112 and the process control system 114 operate independently of each other, save that the control system 114 may execute setpoint quantities which have been adjusted in view of an estimate of the actual speed emanating from the motion control system 112. The mutual independence of the two systems 112, 114 may be achieved by letting them execute as different threads in a shared processing resource and/or execute on separate processing resources of the robot controller 110. This architecture of the robot controller 110 may contribute to stable operation of the paint system 100 and an ability to respond quickly to fluctuations in speed or other quantities.

A method 200 for controlling a robot arm 120 and attached spray gun 122 is visualized as the flowchart in FIG. 2. The method also represents an example way of operating the robot controller 110.

The method 200 makes reference to a program, obtained in a first step 210 of the method 200, which comprises an indication of a setpoint speed v* of the robot arm 120 and an indication of a contemporaneous further setpoint fluid flow per unit time dq*/dt of the spray gun 122 and an indication of a contemporaneous further setpoint quantity x* of the spray gun. A tuple (v*,dq*/dt,x*) of values of the contemporaneous setpoint quantities may relate to a surface of the workpiece 130. When the workpiece 130 is a vehicle, the surface may be a roof, ceiling, door, fender etc.

In a second step 220 of the method 200, an estimate v of the actual speed of the robot arm 120 is obtained while the robot arm 120 and spray gun 122 are processing said surface of the workpiece 130 for which the tuple of values of the contemporaneous setpoint quantities is valid. The estimate v may be derived from a robot arm motion control signal or signals u₁ generated by the motion control system 112 without relying on a sensed momentary speed of the robot arm 120. Alternatively, the estimate v is a reading of a sensor (not shown) arranged on or at the robot arm 120. The sensor may be an inertial sensor or an optical sensor. If the robot arm’s 120 speed relative to the workpiece 130 is of interest, it may be preferable to use an optical sensor; the relative speed may be determined by tracking visual features on the surface of the workpiece 130, computing an optical flow and similar techniques. Further alternatively, the estimate may be derived from a sensor signal or sensor signals from a rotary position sensor or rotary position sensors attached or associated with respective actuators in the robot arm 120. The rotary position sensors may be implemented as resolvers or rotary encoders, from which the speed information may be computed.

In a third step 230, it is determined whether the estimate v deviates from the setpoint speed v*. If the robot is working close to its limitations in either axis speed or torque there can be a temporary drop in speed. Additionally, the conveyor arrangement 140 may move the workpiece 130 into an inconvenient area, where the robot arm 120 is working close to its kinematic limitation. From the point of view of the robot controller 110, a speed deviation may correspond to fulfilment of a condition on the form |v - v*| ≥ ε for a predetermined constant ε > 0 which represents a tolerance. The tolerance can be set in view of how large thickness deviations in the end result are deemed acceptable, but the tolerance may also reflect the expected amount of noise in the estimation of the robot arm’s 120 speed. If the condition is fulfilled, the third step 230 returns a positive decision (Y branch) and the execution of the method 200 proceeds to the fourth step 240. If instead |v - v*| < ε or the estimate v is not available at this time instant, no deviation is determined to exist (N branch); for this outcome, the execution of the method 200 may continue at the second step 220, possibly after a suitable delay has expired, so that it is meaningful to renew the estimation of the speed of the robot arm 120.

In the fourth step 240, the setpoint fluid flow per unit time is adjusted in accordance with a first compensation function, i.e., from its value dq*/dt according to the indication in the program to an adjusted value, denoted dq̃/dt. There is furthermore an optional adjustment of the contemporaneous further setpoint quantity x* of the spray gun in accordance with a second compensation function, the result of the adjustment being denoted x̃. The adjusted values dq̃/dt and x̃ of the setpoint quantities may then be fed to the spray gun 122 for the remaining duration of the processing of said surface of the workpiece 130. Alternatively, and clearly depending on the total extent of the surface, it may be prudent to renew the estimate v of the robot arm’s 120 speed, so that the adjusted values of the setpoint quantities dq̃/dt and x̃ can be updated. The robot controller 110 may potentially resume use of the setpoint quantities according to the indications in the program in case of the outcome |v - v*| < ε; if the fourth step 240 is terminated for this reason, the execution of the method 200 may continue from the second step 220, as described for the N branch of the third step 230.

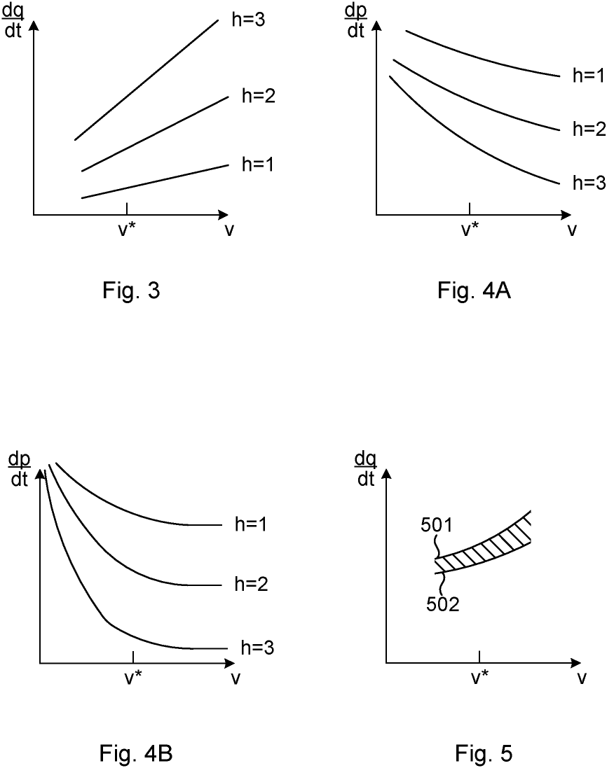

The concept of a compensation function has already been introduced and is further illustrated by the examples in FIGS. 3, 4 and 5.

FIG. 3 shows three compensation functions, corresponding to 1, 2 and 3 units of the thickness h, for the fluid flow per unit time dq/dt. For a different setpoint quantity, a different family of compensation functions may apply. Each compensation function may be understood as a contour line of a completely or incompletely known thickness function. It is sufficient to have local knowledge of the compensation function in a neighborhood of the setpoint speed v*. A possible scheme for utilizing a family of compensation functions like the one shown in FIG. 3 is as follows:
1. That one of the compensation functions which matches the setpoint quantities v*,dq*/dt most closely is selected.
2. The selected compensation function for the estimated actual speed v is evaluated to yield an adjusted setpoint value dq̃/dt.
3. The adjusted setpoint value dq̃/dt is applied to the spray gun.

A determined speed deviation may trigger adjustment of one or more setpoint quantities. For a given setpoint quantity, a different compensation function may apply depending on whether this setpoint quantity is going to be adjusted alone or together with further setpoint quantities. To illustrate this difference, FIG. 4A is a plot of a family of compensation functions to be used if the air flow per unit time dp/dt is adjusted in combination with the fluid flow per unit time dq/dt. If instead the air flow per unit time dp/dt is the sole quantity that is to be adjusted in response to a speed deviation, then the compensation functions in FIG. 4B shall be used. As seen from a comparison of FIGS. 4A and 4B, the somewhat steeper slope in FIG. 4B corresponds to a relatively more vigorous response.

With reference to the fluid flow per unit time dq/dt again, FIG. 5 depicts an alternative representation of a compensation function for one thickness value h = h₀. FIG. 5 shows a hashed area enclosed by an upper bound 501 and a lower bound 502, which define a permissible range of the fluid flow per unit time for each value of the speed v in the neighborhood of the setpoint speed v*. It is noted that the spacing of the bounds 501, 502 is non-constant with respect to the speed v, which reflects that non-exact control of the fluid flow per unit time dq/dt is somewhat more acceptable for higher values in this example use case. The fact that a range of fluid flow values is allowable for each speed value v offers the robot controller 110 some freedom as to whether a small speed deviation shall be treated as negligible or shall trigger an adjustment; in this example, this freedom exists for the fluid flow but possibly not for other setpoint quantities.

As an alternative to using a compensation function of the type illustrated in FIGS. 3-5, an incremental compensation may be applied. More precisely, letting s denote the distance traveled by the TCP 126, one realizes from the chain rule,

$$\frac{d {q}^{∗}}{d t} = \frac{d {q}^{∗}}{d s} v ,$$

that the differential relationship

$$\text{Δ} \frac{d {q}^{∗}}{d t} = \frac{d {q}^{∗}}{d s} \text{Δ} v$$

holds for small Δv. Here dq*/ds may be understood as the setpoint fluid flow per unit distance travelled by the TCP 126 or equivalently the spray gun 122. It follows that the adjusted setpoint fluid flow per unit time can be computed as the setpoint flow per unit time dq*/dt indicated in the program with the addition of a correction term:

$$\frac{d \tilde{q}}{d t} = \frac{d {q}^{∗}}{d t} + \frac{d {q}^{∗}}{d s} \left(v - {v}^{∗}\right) .$$

A further conclusion to be drawn from this is that the slope of the first compensation function at the setpoint speed v* is proportional to a factor representing a desired fluid flow per unit length travelled by the spray gun 122 or TCP 126. This factor may be derived from the setpoint speed and setpoint fluid flow per unit time indicated in the executing program.

A still further alternative is to adjust the setpoint quantities on the basis of tabulated values.

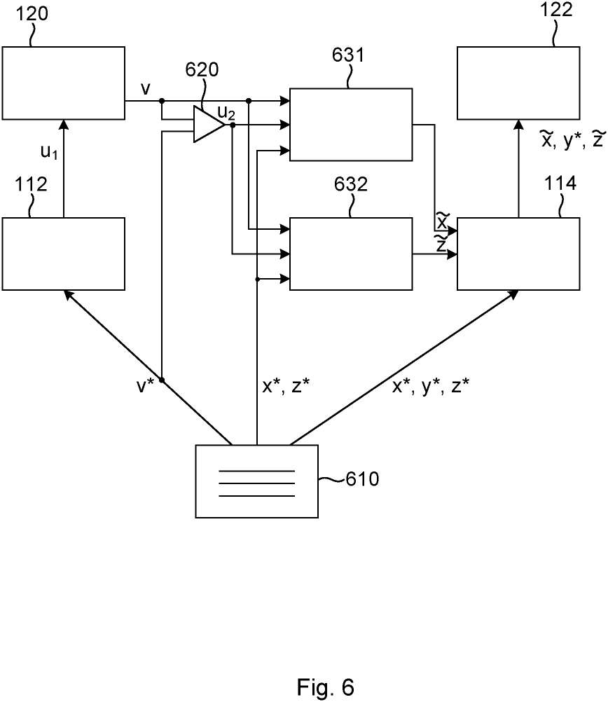

The architecture according to FIG. 6, where control algorithms suitable for controlling a robot arm and connected spray gun cooperate, will now be described. Reappearing from FIG. 1, the motion control system 112 is configured to generate a motion control signal or signals u₁ to be fed to actuators in the robot arm 120, and the process control system 114 controls the spray gun 122 on the basis of adjusted and unadjusted setpoint quantities x̃, y*, z̃. These entities of the robot controller 110 operate on the basis of a program 610, which contains indications of a setpoint speed v* and three setpoint quantities x*, y*, z*. By monitoring the robot arm 120 or the motion control signal u₁ (FIG. 6 depicts the former option), an estimate v of the actual speed of the robot arm 120 is fed to a comparator 620, configured to determine whether it deviates from the setpoint speed v*. If this is the case, the comparator 620 emits an activation signal u₂ directed to a first compensator 631 configured to output, in an active mode, an adjusted value x̃ of the first setpoint quantity x*. The activation signal u₂ from the comparator 620 furthermore activates a second compensator 632 configured to output, in the active mode, an adjusted value z̃ of the third setpoint quantity z*. The adjusted values x̃, z̃ of the first and third setpoint quantities are supplied to the process control system 114. It is noted that the motion control system 112 operates on the basis of the indications in program 610 but independently from the process control system 114. The comparator 620 and compensators 631, 632 may be implemented as application-specific circuitry or by software instructions.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims.

1. A robot controller adapted to execute a program comprising an indication of a setpoint speed of a robot arm, an indication of a contemporaneous setpoint fluid flow per unit time of a spray gun supported by the robot arm, and an indication of a contemporaneous further setpoint quantity of the spray gun, wherein the robot controller is configured to:
obtain an estimate of actual speed of the robot arm;
determine whether the estimate deviates from the setpoint speed; and,
in case of a deviation, adjust the setpoint fluid flow per unit time in accordance with a first compensation function.

2. The robot controller of claim 1, wherein the robot controller is further configured to concurrently adjust, in case of a deviation, the further setpoint quantity in accordance with a second compensation function, which is different from the first compensation function.

3. The robot controller of claim 1, wherein the further parameter is a quantitative characteristic of one or more of: atomization, air flow per unit time, spray plume geometry, electrostatic charging.

4. The robot controller of claim 1, wherein the estimate is derived from a robot arm motion control signal or signals generated by the robot controller without relying on a sensed momentary speed of the robot arm.

5. The robot controller of claim 1, wherein the estimate is derived from a sensor signal or sensor signals from a rotary position sensor or rotary position sensors attached to respective actuator or actuators.

6. The robot controller of claim 1, wherein the estimate is derived from a sensor on or at the robot arm.

7. The robot controller of claim 6, wherein the sensor is an inertial sensor and/or an optical sensor.

8. The robot controller of claim 1, wherein a slope of the first compensation function is proportional to a first factor representing a desired fluid flow per unit length travelled by the spray gun, wherein the robot controller is configured to derive the first factor from the indicated setpoint speed and setpoint fluid flow per unit time.

9. The robot controller of claim 1, adapted to control robot painting of a moving workpiece, particularly an object moved by a conveyor arrangement, wherein the actual speed of the robot arm is speed relative to the moving workpiece.

10. The robot controller of claim 1, comprising:
a motion control system for controlling the robot arm; and
a process control system for controlling the spray gun,
wherein the motion control system operates independently from the process control system.

11. A method of controlling a robot arm and a spray gun supported by the robot arm, the method comprising:
obtaining a program having an indication of a setpoint speed of the robot arm and an indication of a contemporaneous further setpoint fluid flow per unit time of the spray gun and an indication of a contemporaneous further setpoint quantity of the spray gun;
obtaining an estimate of actual speed of the robot arm;
determining whether the estimate deviates from the setpoint speed; and
adjusting, in case of a deviation, the setpoint fluid flow per unit time in accordance with a first compensation function.

12. A computer program comprising instructions to cause a robot controller to perform the steps of:
obtaining a program having an indication of a setpoint speed of the robot arm and an indication of a contemporaneous further setpoint fluid flow per unit time of the spray gun and an indication of a contemporaneous further setpoint quantity of the spray gun;
obtaining an estimate of actual speed of the robot arm;
determining whether the estimate deviates from the setpoint speed: and
adjusting, in case of a deviation, the setpoint fluid flow per unit time in accordance with a first compensation function.

13. A data carrier having stored thereon a computer program comprising instructions to perform the steps of controlling a robot arm and a spray gun supported by the robot arm, the instructions including:
obtaining a program having an indication of a setpoint speed of the robot arm and an indication of a contemporaneous further setpoint fluid flow per unit time of the spray gun and an indication of a contemporaneous further setpoint quantity of the spray gun:
obtaining an estimate of actual speed of the robot arm;
determining whether the estimate deviates from the setpoint speed; and
adjusting, in case of a deviation, the setpoint fluid flow per unit time in accordance with a first compensation function.

14. The robot controller of claim 2, wherein the further parameter is a quantitative characteristic of one or more of: atomization, air flow per unit time, spray plume geometry, electrostatic charging.

15. The robot controller of claim 2, wherein the estimate is derived from a robot arm motion control signal or signals generated by the robot controller without relying on a sensed momentary speed of the robot arm.

16. The robot controller of claim 2, wherein the estimate is derived from a sensor signal or sensor signals from a rotary position sensor or rotary position sensors attached to respective actuator or actuators.

17. The robot controller of claim 2, wherein the estimate is derived from a sensor on or at the robot arm.

18. The robot controller of claim 2, wherein a slope of the first compensation function is proportional to a first factor representing a desired fluid flow per unit length travelled by the spray gun, wherein the robot controller is configured to derive the first factor from the indicated setpoint speed and setpoint fluid flow per unit time.

19. The robot controller of claim 2, adapted to control robot painting of a moving workpiece, particularly an object moved by a conveyor arrangement, wherein the actual speed of the robot arm is speed relative to the moving workpiece.
